(19) United States
(12) Patent Application Publication
(10) Pub. No.: US 2024/0255646 A1
(43) Pub. Date: Aug. 1, 2024

(54) RECEIVING DEVICE OF A DETECTION DEVICE, DETECTION DEVICE, VEHICLE COMPRISING AT LEAST ONE DETECTION DEVICE AND METHOD FOR OPERATING AT LEAST ONE DETECTION DEVICE

(71) Applicant: VALEO SCHALTER UND SENSOREN GMBH, Bietigheim-Bissingen (DE)

(72) Inventors: Haiyue Yang, Bietigheim-Bissingen (DE); Bernd Bertschinger, Bietigheim-Bissingen (DE); Christoph Parl, Bietigheim-Bissingen (DE)

(73) Assignee: VALEO SCHALTER UND SENSOREN GMBH, Bietigheim-Bissingen (DE)

(21) Appl. No.: 18/565,273

(22) PCT Filed: May 24, 2022
(86) PCT No.: PCT/EP2022/063967

§ 371 Date: Nov. 29, 2023

(30) Foreign Application Priority Data
May 31, 2021 (DE) 10 2021 113 962.7

(51) Int. Cl. G01S 17/931

(52) U.S. Cl. CPC G01S 17/931

(57) ABSTRACT

A receiving device of a detection device for detecting objects by electromagnetic scanning signals is disclosed. The receiving device includes at least two receiver regions of at least one receiver, and at least one diffraction element. The receiver regions are able to convert electromagnetic signals into electrical received signals. The diffraction element produces a diffractive effect on electromagnetic signals. The diffraction element is arranged in a signal path of the electromagnetic signals upstream of the at least two receiver regions. At least one diffraction element is designed to divide intensities of incident electromagnetic signals into at least two electromagnetic signal components which are propagating on different signal paths. The at least one diffraction element and the at least two receiver regions are matched to one another to allocate at least two different signal paths to different receiver regions.

### TECHNICAL FIELD

The invention relates to a receiving device of a detection device for detecting objects by means of electromagnetic signals, having at least two receiver regions of at least one receiver, which can convert electromagnetic signals into electrical received signals, and having at least one diffraction element having a diffractive effect on electromagnetic signals, which diffraction element is arranged in a signal path of the electromagnetic signals upstream of the at least two receiver regions.

The invention further relates to a detection device for detecting objects by means of electromagnetic signals, having at least one transmission device which can transmit electromagnetic scanning signals, having at least one receiving device which can detect electromagnetic echo signals derived from reflected electromagnetic scanning signals, and having at least one control and evaluation device which can control the detection device and process electrical received signals, wherein the at least one receiving device has at least two receiver regions of at least one receiver, which can convert electromagnetic echo signals into electrical received signals, and at least one diffraction element having a diffractive effect on electromagnetic echo signals, which diffraction element is arranged in a signal path of the electromagnetic echo signals upstream of the at least two receiver regions.

In addition, the invention relates to a vehicle having at least one detection device for detecting objects by means of electromagnetic signals, the at least one detection device having at least one transmission device which can transmit electromagnetic scanning signals, at least one receiving device which can detect electromagnetic echo signals derived from reflected electromagnetic scanning signals, and at least one control and evaluation device which can control the detection device and process electrical received signals, wherein the at least one receiving device has at least two receiver regions of at least one receiver, which can convert electromagnetic echo signals into electrical received signals, and at least one diffraction element having a diffractive effect on electromagnetic echo signals, which diffraction element is arranged in a signal path of the electromagnetic echo signals upstream of the at least two receiver regions.

Furthermore, the invention relates to a method for operating a detection device for detecting objects by means of electromagnetic signals, in which at least one transmitting device transmits electromagnetic scanning signals, at least one receiving device is used to detect electromagnetic echo signals derived from reflected electromagnetic scanning signals, wherein at least one diffraction element of the at least one receiving device diffracts the electromagnetic echo signals and the diffracted electromagnetic echo signals are converted into electrical received signals using at least two receiver regions of at least one receiver, and at least one control and evaluation device processes the electrical received signals.

### PRIOR ART

Document DE 10 2017 201 127 A1 discloses an optical arrangement for receiving light waves, having a receiving optics for focusing at least one incoming light wave onto a surface of a detector for detecting the at least one light wave, wherein at least one diffractive optical element with a planar extension is arranged between the receiving optics and the detector, and wherein the at least one diffractive optical element has a surface with a surface structure having at least one optical function. Furthermore, a LIDAR device having such an optical arrangement is known.

The object of the invention is to design a receiving device, a detection device, a vehicle, and a method of the type mentioned at the outset, which allows a dynamic range in the detection of electromagnetic signals to be increased.

### DISCLOSURE OF THE INVENTION

This object is achieved according to the invention in the case of the receiving device in that at least one diffraction element is designed for dividing the intensities of incident electromagnetic signals into at least two electromagnetic signal components that are propagating on different signal paths, and the at least one diffraction element and the at least two receiver regions are matched to one another in such a manner that at least two different signal paths for electromagnetic signal components are allocated to different receiver regions.

According to the invention, at least one diffraction element is arranged in a signal path of the incident electromagnetic signals upstream of the receiver regions. The at least one diffraction element can diffract the electromagnetic signals in such a way that their respective intensities are divided across at least two electromagnetic signal components. The signal components propagate on different signal paths. The signal paths are assigned to different receiver regions, so that the signal components are accordingly detected from different receiver regions. In this way, the respective intensity component which is allocated to each of the individual receiver regions is lower than the intensity of the incoming electromagnetic signals. This prevents overloading of individual receiver regions. Splitting the intensity of a received electromagnetic signal across multiple receiver regions can avoid overloading a single receiver region.

Using the invention, electromagnetic signals with a greater intensity can be detected without overloading than would be possible with the detection of the electromagnetic signals using only one receiver region. This allows longer recording times, so that even relatively weak electromagnetic signals can be detected. This allows the dynamic range between the largest and smallest detectable signal intensity to be increased.

The receiving device according to the invention also allows relatively strong electromagnetic echo signals to be detected without overloading. Such strong electromagnetic echo signals may originate from scanning signals which are reflected at objects that are located a relatively short distance away and/or have highly reflective, in particular retroreflective, surfaces.

Diffraction elements can be implemented and assembled with relatively little effort, in particular little production effort, assembly effort and/or expenditure. In addition, diffraction elements are relatively robust. Thus, the receiving device can also be used under harsh operating conditions, such as can occur in particular when used in a vehicle.

The increased dynamic range allows the use of the receiving device according to the invention in application areas in which situations can occur that lead to increased background noise, in particular due to solar radiation. This can be the case when the detection device is used in a vehicle.

Furthermore, the invention allows the use of the receiving device in application areas in which objects with strongly differing reflectivities are to be detected, as may be the case in particular in road traffic. On the one hand, in road traffic the detection device is intended to be used to detect retroreflective objects, in particular in the form of road signs or the like, and on the other hand, poorly reflective objects, in particular persons in dark clothing or dark vehicles. The inventive receiving device can be used to detect a large bandwidth with regard to the reflectivity of objects, approximately between 5% and 95%.

Advantageously, the electromagnetic scanning signals can be in particular pulsed light signals, in particular laser signals. Light signals can be easily achieved. Using lasers, monochromatic scanning signals can be implemented.

Advantageously, the detection device can operate according to a signal time-of-flight method, in particular a signal pulse time-of-flight method. Detection devices operating according to the signal pulse time-of-flight method can be designed and referred to as time-of-flight (TOF) systems, light detection and ranging (LiDAR) systems, laser detection and ranging (LaDAR) systems or the like.

Advantageously, the detection device can be designed as a scanning system. In this case, a monitoring region can be sampled, that is to say scanned, using electromagnetic scanning signals. For this purpose, the propagation directions of the scanning signals can be varied, in particular swept, over the monitoring region. In this case, at least one signal deflection device, in particular a scanning device, a deflection mirror device, or the like can be used. The detection device can alternatively be embodied as a so-called flash system, in particular as flash LiDAR. In a flash system, appropriately spread scanning signals can simultaneously irradiate a relatively large part of the monitoring region or the entire monitoring region.

Advantageously, the detection device can be designed as a laser-based distance measurement system. Laser-based distance measurement systems can include lasers, in particular diode lasers, as signal sources. In particular, pulsed laser beams can be transmitted as scanning signals using lasers. The laser can be used to emit transmission signals in wavelength ranges that are visible or invisible to the human eye. Similarly, receivers of the detection device can comprise or consist of sensors designed for the wavelength of the emitted scanning signals, in particular point sensors, line sensors and/or surface sensors, in particular (avalanche) photodiodes, photodiode lines, CCD sensors, active pixel sensors, in particular CMOS sensors, or the like. Laser-based distance measurement systems can advantageously be designed as laser scanners. Monitoring regions can be scanned in particular with pulsed laser scanning signals, in particular laser beams, using laser scanners.

The invention can advantageously be used in vehicles, in particular motor vehicles. The invention can advantageously be used in land vehicles, in particular passenger vehicles, trucks, buses, motorcycles or the like, aircraft, in particular drones, and/or watercraft. The invention can also be used in vehicles that may be operated autonomously or at least semiautonomously. However, the invention is not restricted to vehicles. It can also be used in stationary operation, in robotics and/or in machines, in particular construction or transport machinery, such as cranes, excavators or the like.

The detection device can advantageously be connected to or can be part of at least one electronic control device of a vehicle or of a machine, in particular a driver assistance system and/or a chassis control system and/or a driver information device and/or a parking assistance system and/or a gesture recognition system or the like. In this way, at least a part of the functions of the vehicle or of the machine can be performed autonomously or semiautonomously.

The detection device can be used for detecting stationary or moving objects, in particular vehicles, persons, animals, plants, obstacles, roadway irregularities, in particular potholes or rocks, roadway boundaries, traffic signs, open spaces, in particular parking spaces, precipitation or the like, and/or movements and/or gestures.

In an advantageous embodiment, at least one diffraction element can have at least one grating-like structure and/or at least one diffraction element can have or consist of at least one diffractive optical element. Such diffraction elements can be used to diffract electromagnetic signals. The diffraction can be used to divide the intensity of the electromagnetic signals across multiple signal components.

Advantageously, at least one diffraction element can be realized by means of holograms, holographic gratings or the like. In this way, the diffraction elements can be produced more easily in industry.

Advantageously, at least one diffraction element can have structures on which electromagnetic signals, in particular light waves, are diffracted. Due to interference effects, the intensities of incident electromagnetic signals behind the at least one diffraction element can be divided over multiple electromagnetic signal components.

In a further advantageous embodiment, at least one diffraction element for electromagnetic signals can be at least partially reflective and/or at least partially transmissive and/or at least one diffraction element can be arranged in the signal path to be reflective for electromagnetic signals and/or at least one diffraction element can be arranged in the signal path to be transmissive for electromagnetic signals. In this way, the receiving device arrangement can be designed to be more flexible overall.

Advantageously, at least one diffraction element for electromagnetic signals can be exclusively reflective. In this way, the electromagnetic signals can additionally be deflected. The at least one diffraction element and the at least one receiver thus need not be arranged in a line with respect to the direction of the electromagnetic signals incident on the receiving device.

Alternatively or in addition, at least one diffraction element for electromagnetic signals can be exclusively transmissive. In this way, the at least one diffraction element and at least one receiver can be arranged in a line with respect to the direction of the electromagnetic signals impinging on the receiving device.

Alternatively or additionally, at least one diffraction element for electromagnetic signals can be partially transmissive and partially reflective. In this way, a portion of the intensity of the incident electromagnetic signals can be reflected and a portion can be allowed to pass through the at least one diffraction element. In particular, multiple receivers can be used. Advantageously, one of the receivers can be arranged in line with the at least one diffraction element and can receive the transmitted signal components. Another receiver may be arranged next to the at least one diffraction element and can receive the reflected electromagnetic signal components.

In a further advantageous embodiment, at least one diffraction element for dividing intensities in only one dimension can be embodied transversely, in particular perpendicular, to signal paths of incident electromagnetic signals and/or at least one diffraction element for dividing intensities in two dimensions can be embodied transversely, in particular perpendicular, to signal paths of incident electromagnetic signals.

In the case of a division of intensities of incident electromagnetic signals in only one dimension, the receiver regions can be arranged side by side, in particular in the form of a line. The receiver regions of the receiver can be arranged in rows or in two dimensions.

If two-dimensionally arranged receiver regions are used in conjunction with the division of the intensities in only one dimension, a second dimension which runs transversely, in particular perpendicular, to the first dimension and transversely, in particular perpendicular, to the signal paths, can be used for detecting a direction from which a detected electromagnetic signal is coming.

In the case of a division of intensities of incident electromagnetic signals in two dimensions over multiple two-dimensionally arranged receiver regions, the at least one receiver may be designed more compact overall.

In a further advantageous embodiment, the receiving device for detecting electromagnetic signals may be configured with a high dynamic range. In this way, the receiving device can be used in applications where there are large differences in the intensities of the electromagnetic signals to be detected.

The dynamic range is the quotient of the maximum and minimum intensities of the electromagnetic signals. A high dynamic range (HDR) is used to describe ratios greater than 1000:1, in particular greater than 10,000:1.

The detection of electromagnetic signals with a high dynamic range allows the use of the receiving device according to the invention in connection with detection devices which work according to a so-called multiple-shot method. In this case, in a measurement, in particular a distance measurement, a direction measurement and/or a speed measurement, a transmitting device is used to send multiple electromagnetic scanning signals sequentially into a monitoring area and the corresponding reflected electromagnetic echo signals are received with the receiving device. The echo signals can be detected with different detection times. The sequentially detected echo signals are combined for one measurement. This results in longer overall integration times for detecting the echo signals. A larger dynamic range can thus be achieved.

In a further advantageous embodiment, at least one receiver can have or consist of at least one line sensor, and/or at least one receiver can have or consist of at least one surface sensor, and/or at least one receiver region can be realized with at least one receiver element.

In the case of a line sensor, the receiver elements are arranged in a row. Multiple receiver regions can be arranged side by side in a spatial dimension. This can reduce the number of required receiver regions and the time required to read off the receiver regions.

In the case of a surface sensor, the receiver elements are arranged two-dimensionally. In the case of a surface sensor, the receiver regions can be arranged two-dimensionally. Two spatial dimensions for detecting signal components can thus be realized. Alternatively or additionally, receiver regions can be arranged in rows. Overall, a surface sensor with a plurality of receiver elements and corresponding receiver regions can be realized more compactly and be used more flexibly than a line sensor.

A surface sensor can be used in conjunction with at least one diffraction element, which divides the intensities of incident electromagnetic signals in two spatial dimensions. In this way, the intensities can be divided over multiple signal components. This allows the intensities of the individual signal components to be further reduced.

Alternatively, a surface sensor can be used in conjunction with at least one diffraction element, which divides the intensities of incident electromagnetic signals in one spatial dimension. The second spatial dimension which is available due to the surface sensor can be used for determining the direction from which an electromagnetic signal received with the receiving device comes. In this case, the receiving device can be designed such that the electromagnetic received signals are directed onto the corresponding receiver regions of the surface sensor, divided into their signal components in the second spatial dimension, depending on the direction from which they come. From the position of the receiver regions in the second spatial dimension, a direction variable can be determined, which characterizes the direction of the electromagnetic signals. The direction from which the electromagnetic signals, in particular echo signals, come may correspond to the direction in which an object at which the electromagnetic signals were reflected is located.

Alternatively or additionally, at least one receiver region can comprise a receiver element.

A correspondingly high spatial resolution can be achieved with a receiver region consisting of only one receiver element.

With a receiver region having multiple receiver elements, the intensity of the respective signal components can be distributed over multiple receiver elements. The dynamic range can thus be further improved.

Advantageously, a plurality of receiver elements can be combined using so-called “binning” to form a receiver region.

Receiver elements in the context of the invention can also be referred to as “picture elements” or “pixels”.

In a further advantageous embodiment, at least one arrangement having at least one diffraction element and at least two receiver regions can be designed for detecting electromagnetic signals in at least one defined wavelength range, in particular with at least one defined wavelength. In this way, the signal paths of the signal components can be allocated to the corresponding receiver regions more accurately.

Advantageously, at least one arrangement with at least one diffraction element and at least two receiver regions can be designed for detecting monochromatic light, in particular laser signals. Thus, the signal components divided with the at least one diffraction element can be directed to the corresponding receiver regions more accurately.

The object is further achieved according to the invention in the case of the detection device by the fact that at least one diffraction element is designed for dividing the intensities of incident electromagnetic echo signals into at least two electromagnetic signal components that are propagating on different signal paths, and the at least one diffraction element and the at least two receiver regions are matched to one another in such a manner that at least two different signal paths for electromagnetic signal components are allocated to different receiver regions.

According to the invention, at least one receiving device has at least one diffraction element, which divides incident echo signals into at least two electromagnetic signal components. The at least two electromagnetic signal components are directed by the at least one diffraction element to different receiver regions and converted by them into electrical received signals.

Advantageously, at least one transmitting device can comprise at least one signal source for generating electromagnetic scanning signals. The at least one transmitting device and the at least one receiving device can be operated so as to be matched to one another with at least one control and evaluation device. In this way, in particular using a signal time-of-flight method, object information, in particular distances, directions and/or speeds of objects relative to the detection device, can be determined on the basis of the echo signals.

At least one transmitting device can advantageously have at least one optical system, in particular at least one optical lens or the like. With optical systems, the scanning signals can be manipulated, in particular spread and/or focused.

At least one transmission device can advantageously have at least one signal deflection device, in particular a deflecting mirror, a MEMS mirror or the like. In this way, the electromagnetic scanning signals can be directed into at least one monitoring area.

The at least one signal deflection device can advantageously be modifiable, in particular adjustable. In this way, the propagation direction of the electromagnetic scanning signals can be varied. Thus, the monitoring area can be sampled, in particular scanned with the at least one electromagnetic scanning signal. Advantageously, the at least one signal deflection device can have at least one vibration mirror or vibration mirror arrangement. The direction of the electromagnetic scanning signals can thus be continuously varied.

Advantageously, at least one control and evaluation device can be implemented in a centralized or decentralized manner with one or more components. In this case, the at least one control and evaluation device can be partially implemented with the at least one transmitting device and/or the at least one receiving device.

The at least one control and evaluation device can advantageously be implemented by means of software and/or hardware solutions.

Advantageously, using at least one control and evaluation device, object variables which characterize distances, directions and/or speeds of objects relative to detection devices, can be determined from electrical received signals. These object variables can be further processed by appropriate electrical means.

In an advantageous embodiment, at least one transmitting device can have at least one signal source, which can be used to generate electromagnetic scanning signals in at least one defined wavelength range, in particular with at least one defined wavelength. In this way, the electromagnetic echo signals derived from the reflected scanning signals can be more precisely allocated to the corresponding receiver regions using the at least one diffraction element.

Advantageously, at least one transmitting device can have at least one laser as a signal source. A laser can be used to generate monochromatic light signals.

Furthermore, the object according to the invention in the case of the method is achieved by the fact that at least one diffraction element is designed for dividing the intensities of incident electromagnetic echo signals into at least two electromagnetic signal components that are propagating on different signal paths, and the at least one diffraction element and the at least two receiver regions are matched to one another in such a manner that at least two different signal paths for electromagnetic signal components are allocated to different receiver regions.

Advantageously, at least one monitoring area outside the vehicle and/or within the vehicle can be monitored with the detection device, in particular to detect objects.

In an advantageous embodiment, the vehicle can have at least one driver assistance system. The vehicle can be operated autonomously or semiautonomously by means of a driver assistance system.

Advantageously, at least one detection device can be functionally connected to at least one driver assistance system. In this way, information about a monitoring area, in particular object information, which is obtained with the at least one detection device, can be used with the at least one driver assistance system for controlling an autonomous or semiautonomous operation of the vehicle.

In addition, the object is achieved according to the invention in the case of the method by the fact that using at least one diffraction element, the intensity of the incident electromagnetic echo signals is divided into at least two electromagnetic signal components, which are propagating on different signal paths, and the at least two electromagnetic signal components are directed onto different receiver regions.

According to the invention, the intensity of the incident electromagnetic echo signals is divided over multiple receiver regions. This prevents overloading from occurring in individual receiver regions due to strong electromagnetic echo signals.

Advantageously, using the at least one control and evaluation device the electrical received signals can be processed into variables which can characterize distances, directions and/or speeds of detected objects relative to the detection device. In this way, corresponding information about detected objects can be determined with the detection device.

Moreover, the features and advantages disclosed in conjunction with the receiving device according to the invention, the detection device according to the invention, the vehicle according to the invention, and the method according to the invention and the respective advantageous embodiments thereof apply accordingly to one another and vice versa. The individual features and advantages can of course be combined with one another, wherein further advantageous effects that go beyond the sum of the individual effects may result.

### BRIEF DESCRIPTION OF THE DRAWINGS

Further advantages, features and details of the invention will become apparent from the following description, in which exemplary embodiments of the invention are explained in greater detail with reference to the drawing. A person skilled in the art will expediently also consider individually the features that have been disclosed in combination in the drawing, the description and the claims and will combine them to form meaningful further combinations. In the schematic figures

FIG. 1 shows a front view of a vehicle having a driver assistance system and a LIDAR system for detecting objects in the direction of travel in front of the vehicle;

FIG. 2 shows a functional illustration of the vehicle having the driver assistance system and the LiDAR system from FIG. 1;

FIG. 3 shows a receiving device according to a first exemplary embodiment for the LIDAR system of FIGS. 1 and 2, having a receiver and a reflecting diffraction element with which intensities of received echo signals in one spatial dimension are divided into signal components which are directed onto receiver regions of the receiver that are arranged in a row;

FIG. 4 shows a plan view of the receiver from FIG. 3;

FIG. 5 shows an intensity distribution of the signal components of an exemplary echo signal behind the diffraction element from FIG. 3;

FIG. 6 shows a receiving device according to a second exemplary embodiment of the LiDAR system of FIGS. 1 and 2, comprising a receiver in which the receiver regions are arranged in a row, and a transmissive diffraction element;

FIG. 7 shows a receiving device according to a third exemplary embodiment for the LiDAR system of FIGS. 1 and 2, having a receiver in which the receiver regions are arranged two-dimensionally, and a transmissive diffraction element with which intensities of echo signals in one spatial dimension are resolved into signal components and echo signals from different directions are directed onto different groups of receiver regions;

FIG. 8 shows a plan view of the receiver from FIG. 7;

FIG. 9 shows a receiving device according to a fourth exemplary embodiment for the LiDAR system of FIGS. 1 and 2, having a receiver in which the receiver region is arranged two-dimensionally, and a transmissive diffraction element with which intensities of echo signals in two spatial dimensions are divided into signal components and directed onto the corresponding receiver regions;

FIG. 10 shows a plan view of the receiver from FIG. 9.

In the figures, identical components are provided with identical reference signs.

### EMBODIMENT(S) OF THE INVENTION

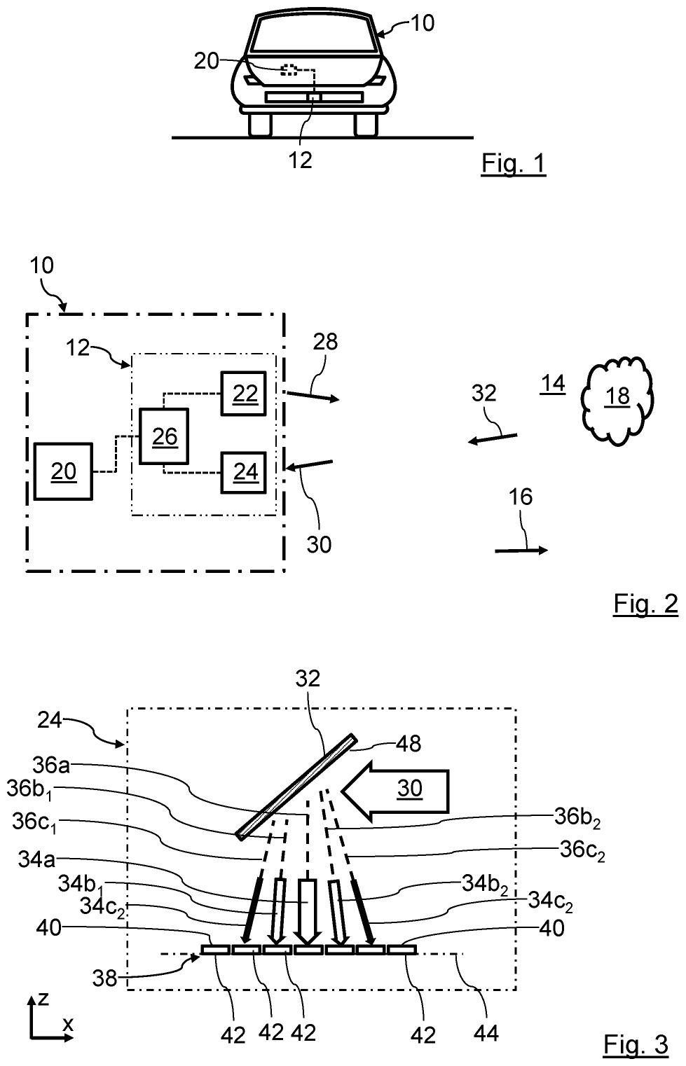

FIG. 1 shows a front view of a vehicle 10 by way of example in the form of a passenger vehicle.

The vehicle 10 has a detection device by way of example in the form of a LIDAR system 12. The LiDAR system 12 is designed as a laser scanner. FIG. 2 shows a functional illustration of the vehicle 10 having the LiDAR system 12.

By way of example, the LiDAR system 12 is arranged in the front fender of the vehicle 10. The LiDAR system 12 may be used to monitor a monitoring region 14 in front of the vehicle 10 in the direction of travel 16 for objects 18. The LiDAR system 12 can also be arranged at another location on the vehicle 10 and oriented differently. The LiDAR system 12 can also be arranged in the vehicle 10 for monitoring an interior. The LiDAR system 12 may be used to ascertain object information, for example distances, directions, and speeds of objects 18 relative to the vehicle 10, or to the LiDAR system 12, respectively, or corresponding characterizing variables.

The objects 18 may be stationary or moving objects, for example other vehicles, persons, animals, plants, obstacles, road irregularities, for example potholes or rocks, roadway boundaries, traffic signs, free spaces, for example parking spaces, precipitation or the like. Gestures of persons can also be detected using the LiDAR system 12.

The LiDAR system 12 is connected to a driver assistance system 20. The driver assistance system 20 can be used to operate the vehicle 10 autonomously or semiautonomously.

The LiDAR system 12 comprises, by way of example, a transmitting device 22, a receiving device 24 and a control and evaluation device 26.

The functions of the control and evaluation device 26 can be performed in a centralized or decentralized manner. Parts of the functions of the control and evaluation device 26 can also be integrated in the transmission device 22 and/or the receiving device 24. The control and evaluation device 26 and the driver assistance system 20 may also be partially combined. The functions of the control and evaluation device 26 are implemented by software and hardware.

Electrical transmission signals are generated using the control and evaluation device 26 to carry out measurements using the LiDAR system 12. The transmitting device 22 is activated using the electrical transmission signals, so that it transmits corresponding monochromatic electromagnetic scanning signals 28 in the form of laser signals. The transmitting device 22 has a signal source, for example, in the form of a diode laser for this purpose. For example, pulsed scanning signals 28 are emitted using the signal source.

The LiDAR system 12 can be designed as a scanning LiDAR system or as a flash LiDAR system.

The transmitting device 22 may optionally comprise at least one optical system, for example at least one optical lens, with which the generated scanning signals 28 can be manipulated accordingly, in particular spread and/or focused.

In addition, the transmitting device 22 may optionally have a signal deflection device that can be used to direct the scanning signals 28 into the monitoring area 14. The signal deflection device can be modifiable, for example pivotable. In this way, the propagation directions of the scanning signals 28 can be swept and the monitoring area 14 can be sampled or scanned.

The scanning signals 28 are transmitted into the monitoring area 14 using the transmitting device 22.

The electromagnetic scanning signals 28 reflected at an object 18 in the direction of the receiving device 24 are received as electromagnetic echo signals 30 using the receiving device 24. The receiving device 24 is designed for detecting echo signals 30 with intensities in a high dynamic range.

The receiving device 24 according to a first exemplary embodiment, which can be used in the LiDAR system 12 from FIGS. 1 and 2, is shown in FIG. 3.

The receiving device 24 may optionally have on its input side an echo signal deflection device and/or an optical system, for example an optical lens, with which the electromagnetic echo signals 30 are directed to a reflective diffraction element 32 of the receiving device 24.

The reflective diffraction element 32 has, by way of example, a reflective grating structure. The diffraction element 32 can be realized for example as a diffractive optical element. The diffraction element 32 has a diffractive effect on the echo signals 30, for example in a spatial dimension perpendicular to the signal path of the incident echo signals 30.

With the diffraction element 32, the intensity of an incident echo signal 30 is divided by means of diffraction, for example by means of interference, in one spatial dimension over, for example, five signal components 34 and deflected for example by approximately 90°. The signal components 34 are designated in the figures with the reference signs 34a, 34b, namely 34b1 and 34b2, and 34c, namely 34c1 and 34c2 for better differentiation. An example intensity distribution of the signal components 34 is shown in FIG. 5. The intensity distribution in the illustrated exemplary embodiment is symmetrical. The main component of the intensity of the echo signal 30 is assigned to a main signal component 34a. Smaller components of the intensity are assigned in decreasing strength to two first secondary signal components 34b1 and 34b2 and two second secondary signal components 34c1 and 34c2 arranged symmetrically with respect to the main signal component 34a in each case.

The signal components 34a, 34b1, 34b2, 34c1 and 34c2 are propagating on different signal paths 36. The signal paths 36 are designated in the figures with the reference signs 36a, 36b, namely 36b1 and 36b2, and 36c, namely 36c1 and 36c2 for better differentiation.

The signal components 34 are directed by the diffraction element 32 to a receiver 38 of the receiving device 24.

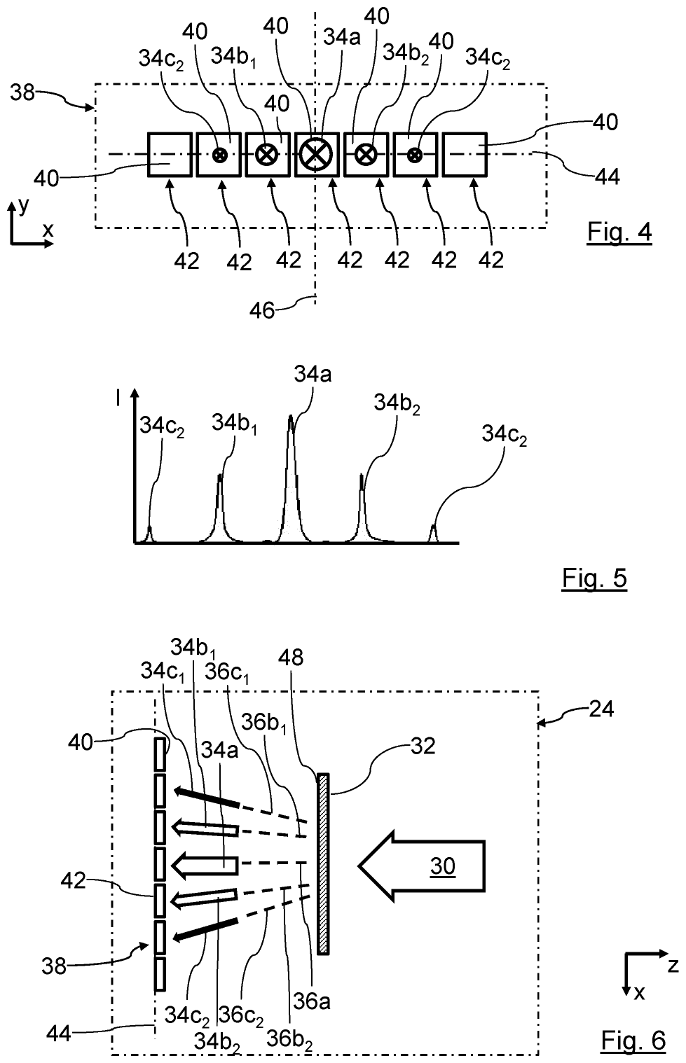

The receiver 38 is implemented by way of example as a CCD sensor. Alternatively, an active pixel sensor, a photodiode line or the like may be provided. The receiver 38 has, for example, seven receiver regions 40, which are arranged side by side as a line along a first sensor axis 44. In FIG. 4, the receiver 38 is shown in plan view as seen from the diffraction element 32. Alternative receivers 38 can also have more or fewer than seven receiver regions 40.

The first sensor axis 44 extends parallel to an x-axis of a Cartesian x-y-z coordinate system, the corresponding coordinate axes of which are shown in FIGS. 3, 4 and 6 to 14 for better orientation. A second sensor axis 46 extends perpendicular to the first sensor axis 44 and parallel to a y-axis of the x-y-z coordinate system. A diffraction element plane 48, along which the grating structures of the diffraction element 32 extend, runs perpendicular to the x-z plane of the x-y-z coordinate system.

As an example, each receiver region 40 comprises one receiver element 42. The receiver element 42 can also be referred to as a pixel. In an exemplary embodiment not shown, multiple receiver elements 42 may also be combined to form a receiver region 40. When using CCD sensors as receivers 38, a so-called binning method can be used, in which multiple receiver elements 42 are combined to form a receiver region 40.

The diffraction element 32 and the receiver 38 are matched to one another, for example, in their configurations, their orientations and/or distances relative to each other, in such a manner that each signal path 36 is assigned to one of the receiver regions 40. In total, the signal paths 36 and the corresponding signal components 34 are allocated to different receiver regions 40. The intensity of the incident echo signal 30 is thus distributed over the signal components 34 onto multiple receiver regions 40.

With the receiver regions 40, the respective signal components 34 of the incident electromagnetic echo signal 30 are converted into corresponding electrical received signals. The electrical received signals are processed using the control and evaluation device 26. For example, object variables, for example, distance variables, direction variables, and/or speed variables, which characterize distances, directions, and speeds respectively of the detected object 18 relative to the LiDAR system 12 or relative to the vehicle 10, are ascertained from the electrical received signals using the control and evaluation device 26.

The ascertained object variables are transmitted to the driver assistance system 20 using the control and evaluation device 26. The object variables are used to operate the vehicle 10 autonomously or semiautonomously using the driver assistance system 20.

For example, solar radiation can cause increased background noise in the operation of the vehicle 10. In addition, for example in road traffic, it must be possible to detect objects 18 with strongly differing reflectivities, for example in ranges between 5% and 95%. Traffic signs with retroreflective properties, for example, exhibit high reflectivity. On the other hand, for example, people in dark clothing have relatively low reflectivity. The division of the intensity of the echo signals 30 over multiple signal components 34 and multiple receiver regions 40 allows a high dynamic range (HDR) with respect to the intensities of the echo signals 30. Thus, both echo signals 30 with high intensities, which when striking a single receiver region 40 lead to overloading, as well as echo signals 30 with low intensities are reliably detected.

FIG. 6 shows a second exemplary embodiment of a receiving device 24 for the LiDAR system 12 from FIGS. 1 and 2. The elements that are similar to those of the first exemplary embodiment from FIGS. 3 and 4 are provided with the same reference signs. The second exemplary embodiment differs from the first exemplary embodiment in that the diffraction element 32 and the corresponding grating structure are transmissive for echo signals 30. The diffraction element 32 is arranged in a line with the receiver 38. With the transmissive diffraction element 32, the intensity of the scanning signals 28, analogously to the first exemplary embodiment, is divided for example into five signal components 34 and directed onto the respective receiver regions 40.

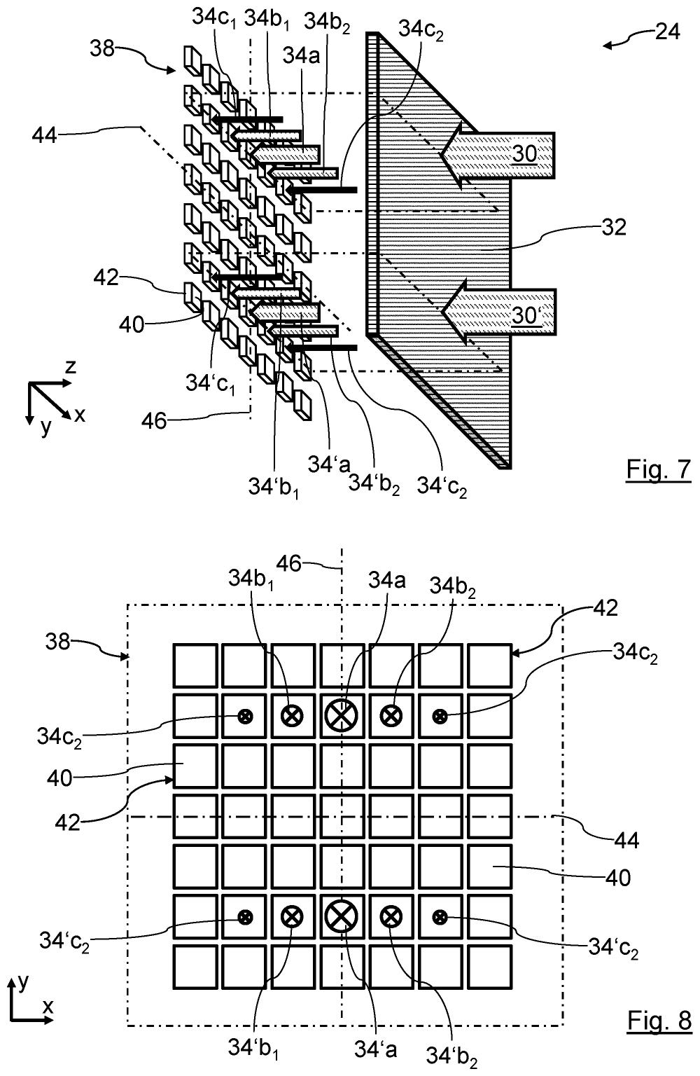

FIG. 7 shows a third exemplary embodiment of a receiving device 24 for the LiDAR system 12 from FIGS. 1 and 2. FIG. 8 shows a plan view of the receiver 38 of the receiving device 24. Those elements which are similar to those of the second exemplary embodiment from FIG. 6 are provided with the same reference signs. The third exemplary embodiment differs from the second exemplary embodiment in that the receiver 38 has, for example, 49 receiver regions 40. The 49 receiver regions 40 are arranged two-dimensionally in seven rows 50 with seven receiver regions 40 each. Due to the two-dimensional arrangement, the receiver 38 has a second spatial dimension along the second sensor axis 46 in addition to the first spatial dimension along the first sensor axis 44.

Each of the rows 50 with seven receiver regions 40 each extends along the first sensor axis 44 in a similar manner to the first two exemplary embodiments. The seven rows 50 are arranged side by side along the second sensor axis 46.

Depending on the direction from which an echo signal 30 comes, the signal components 34 in the second spatial dimension are directed onto the receiver regions 40 of the corresponding row 50. The direction in which the reflecting object 18 is located is also determined from the illuminated receiver regions 40.

With the receiving device 24 according to the third exemplary embodiment, multiple objects 18, which are located, for example, in different directions, can be detected separately. In FIGS. 7 and 8, as an example the case is shown in which respective echo signals 30 and 30′ from two objects 18 are received from different directions.

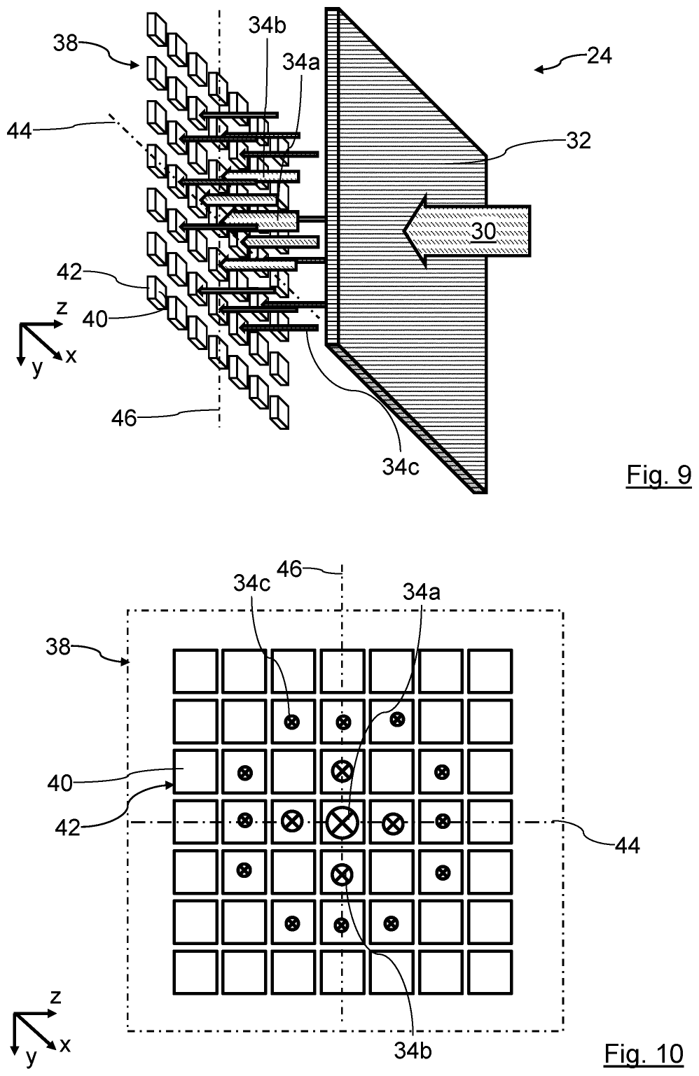

FIG. 9 shows a fourth exemplary embodiment of a receiving device 24. FIG. 10 shows a plan view of the receiver 38 of the receiving device 24. The elements that are similar to those of the third exemplary embodiment from FIGS. 7 and 8 are provided with the same reference signs. The fourth exemplary embodiment differs from the third exemplary embodiment in that echo signals 30 are diffracted in two spatial dimensions by the diffraction element 32. For this purpose, the diffraction element 32 may have, for example, concentric grating structures.

With the diffraction element 32, the intensity of the echo signals 30 is divided by means of diffraction in two spatial dimensions over, for example, 17 signal components 34a, 34b and 34c. The signal paths 36b and 36c of the secondary signal components 34b and 34a are arranged concentrically around the signal path 36a of the main signal component 34a. Analogous to the first three exemplary embodiments, the signal components 34a, 34b and 34c are directed along different signal paths 36a, 36b and 36c to different receiver regions 40 of the receiver 38 and detected by them.

In the fourth exemplary embodiment, the intensity of an incident echo signal 30 is distributed in total over 17 receiver regions 40. Thus, the dynamic range with respect to the intensity of the detected echo signals 30 can be further increased compared to the first three exemplary embodiments.

In further exemplary embodiments not shown, the two-dimensional diffraction elements 30 from the third and fourth exemplary embodiments can be configured as reflective diffraction elements 32 in the same way as the first exemplary embodiment.

1. A receiving device of a detection device for detecting objects by means of electromagnetic signals,
wherein the receiving device comprises at least two receiver regions of at least one receiver,
wherein the receiver regions are able to convert electromagnetic signals into electrical received signals, and
wherein the receiving device further comprises at least one diffraction element that produces a diffractive effect on electromagnetic signals,
wherein the at least one diffraction element is arranged in a signal path of the electromagnetic signals upstream of the at least two receiver regions,
wherein the at least one diffraction element is designed to divide intensities of incident electromagnetic signals into at least two electromagnetic signal components which are propagating on different signal paths, and
wherein the at least one diffraction element and the at least two receiver regions are matched to one another in such a manner that at least two different signal paths for electromagnetic signal components are allocated to different receiver regions.

2. The receiving device as claimed in claim 1,
wherein the at least one diffraction element comprises at least one grating-like structure and at least one diffractive optical element.

3. The receiving device as claimed in claim 1,
wherein at least one diffraction element for electromagnetic signals is at least partially reflective and at least partially transmissive,
and
at least one diffraction element is arranged in the signal path to be reflective for electromagnetic signals,
and
at least one diffraction element is arranged in the signal path to be transmissive for electromagnetic signals.

4. The receiving device as claimed in claim 1,
wherein at least one diffraction element for dividing intensities in one or two dimensions is configured transversely to signal paths of incident electromagnetic signals.

5. The receiving device as claimed in claim 1,
wherein the receiving device is designed for detecting electromagnetic signals with a high dynamic range.

6. The receiving device as claimed in claim 1,
wherein the at least one receiver comprises at least one line sensor, surface sensor, or receiver element,
wherein the receiver element is implemented in the receiver region of the receiver.

7. The receiving device as claimed in claim 1,
wherein the receiving device is configured for detecting electromagnetic signals in at least one defined wavelength range.

8. A detection device for detecting objects by electromagnetic signals,
wherein the detection device comprises:
at least one transmission device which is able to transmit electromagnetic scanning signals,
at least one receiving device which is able to detect electromagnetic echo signals,
wherein the electromagnetic echo signals are derived from reflected electromagnetic scanning signals, and
at least one control and evaluation device, which is able to control the detection device and process electrical received signals,
wherein the at least one receiving device comprises:
at least two receiver regions of at least one receiver,
wherein the receiver regions are able to convert electromagnetic echo signals into electrical received signals, and
at least one diffraction element which is able to have a diffractive effect on electromagnetic echo signals,
wherein the diffraction element is arranged in a signal path of the electromagnetic echo signals upstream of the at least two receiver regions,
wherein the at least one diffraction element is designed to divide intensities of incident electromagnetic echo signals into at least two electromagnetic signal components which are propagating on different signal paths, and
wherein the at least one diffraction element and the at least two receiver regions are matched to one another in such a manner that at least two different signal paths for electromagnetic signal components are allocated to different receiver regions.

9. The detection device as claimed in claim 8,
wherein the at least one transmitting device comprises at least one signal source,
wherein the at least one signal source is able to be used to generate electromagnetic scanning signals in at least one defined wavelength range.

10. A vehicle comprising at least one detection device for detecting objects by means of electromagnetic signals,
wherein the at least one detection device comprises:
at least one transmitting device which is able to transmit electromagnetic scanning signals,
at least one receiving device which is able to detect electromagnetic echo signals,
wherein the electromagnetic echo signals are derived from reflected electromagnetic scanning signals, and
at least one control and evaluation device, which is able to be used to control the at least one detection device and process electrical received signals,
wherein the at least one receiving device comprises:
at least two receiver regions of at least one receiver,
wherein the at least two receiver regions are able to convert electromagnetic echo signals into electrical received signals, and
at least one diffraction element which is able to have a diffractive effect on electromagnetic echo signals,
wherein the diffraction element is arranged in a signal path of the electromagnetic echo signals upstream of the at least two receiver regions,
wherein the at least one diffraction element is designed to divide intensities of incident electromagnetic echo signals into at least two electromagnetic signal components which are propagating on different signal paths, and
wherein the at least one diffraction element and the at least two receiver regions are matched to one another in such a manner that at least two different signal paths for electromagnetic signal components are allocated to different receiver regions.

11. The vehicle as claimed in claim 10,
wherein the vehicle comprises at least one driver assistance system.

12. A method for operating a detection device for detecting objects by means of electromagnetic signals,
the method comprising:
transmitting electromagnetic scanning signals with at least one transmitting device,
using at least one receiving device to detect electromagnetic echo signals,
wherein the electromagnetic echo signals are derived from reflected electromagnetic scanning signals,
diffracting the electromagnetic echo signals with at least one diffraction element of the at least one receiving device,
converting the diffracted electromagnetic echo signals into electrical received signals using at least two receiver regions of at least one receiver, and
processing the electrical received signals with at least one control and evaluation device,
wherein at least one diffraction element divides the intensity of the incident electromagnetic echo signals into at least two electromagnetic signal components, wherein the at least two electromagnetic signal components are propagating on different signal paths, and the at least two electromagnetic signal components are directed to different receiver regions.
